(19) United States
(12) Patent Application Publication
(10) Pub. No.: US 2011/0138677 A1
(43) Pub. Date: Jun. 16, 2011

(54) Mouse catcher

(76) Inventors: Heng Jin Jiao, San Dimas, CA (US); Tsung Yen Wu, San Dimas, CA (US)

(21) Appl. No.: 12/653,724

(22) Filed: Dec. 16, 2009

(51) Int. Cl. A01M 23/14

(52) U.S. Cl. 43/65; 43/67

(57) ABSTRACT

A mouse catcher includes a container for accommodating two or more mice therewithin, a one directional tunnel, and a one directional mechanism. The tunnel is communicatively connected to the container for guiding the mouse passing from the tunnel into the container through a door entrance. The one directional mechanism is provided for allowing the mouse entering only from the one directional tunnel into the container, wherein the one directional mechanism includes a one way gate movably coupling at the door entrance for communicatively guiding the mouse entering only from the tunnel to the container through the one way gate in the one way manner. A bait vessel is further provided within the container for luring the mouse entering the one way gate into the container for being caught, so that the mouse is caught alive, so as to lure another mouse entering container.

### BACKGROUND OF THE PRESENT INVENTION

1. Field of Invention

The present invention relates to an animal catcher, and more particularly to a mouse catcher, which is able to catch two or more mice alive.

2. Description of Related Arts

The animal of rodents, such as house mouse, is considered as one of the most troublesome. From the point of health, the rodents usually have infestations that might infect to human beings. If the human unintentionally swallowed the contaminated food, such as from their urine, the serious disease may occur to cause the health problem, or even death. They are not only consuming the food meant for human, but also damage the structures by constantly gnawing it.

Take the house mice, which are the most common rodents in a house, for example. There are lots of mouse trap for catching the mice for eliminating the mice and preventing the activity of the mice in the house, so as to enhance the safety and keep the environment clean. Therefore, the mouse traps are usually placed in the basement, garage, or other darker or hidden places that mice commonly present.

The simplest methods for trapping the mouse is using a glue trap for adhesively trapping the mouse on the glue trap, so that the mouse is unable to run away. Another common device for catching mouse is a spring-loaded mouse trap, which is normally being placed in the place that the mice might have activities thereof. When the mouse is accidentally touching the actuator to actuate the spring-loaded device, a clip of the spring-loaded mouse trap may be actuated to snap the mouse. There is another traditional trapping cage are provided for catching the mouse. The cage may have a mouse bait therewithin to decoy the mouse going into the cage through a door opener, such that the mouse is trapped in the cage.

However, most of the existing trapping device can only catch one mouse at a time. The mouse is normally a clustering animal, and preferred to live in a group. The mice group may live beneath the basement and came in and out to access the house of human beings from any channel, pips, or holes that communicatively connect to the interior of the house. After one mouse stuck on the glue trap, other mice might warn or learn to avoid it. Even if the glue surface of the glue trap is larger enough to trap two mice, the other mice won't get trapped after one mouse being stuck on the glue trap. Thus, the efficiency of the glue trap for catching the mouse is reduced, and other mice may still live in or around the house and have activities in the human living area.

The spring-loaded mouse trap also has the same issue of the glue trap. After the spring-loaded mouse trap is actuated to snap the mouse, the spring-loaded mouse trap normally is unable to trap the other mouse. The snapped mouse is usually being hurt or killed by the spring-loaded mouse trap. It is not only preventing the other mice being trapped after they saw the hurt or killed mouse, but also arise the humanity issue. The mouse may have been suffered from the injury of the spring-loaded mouse trap for a long period before death.

The cage for catching the mouse normally has an automatic gate opener that enables the mouse entering into the cage. However, type of mouse trap tends to be complicated in structure and design. Traditionally the cage can only accommodate one mouse therewithin. The cage, glue trap, and the spring-loaded mouse trap also have the common concerning issue of removing the caught mouse. In order to not touch the mouse to prevent any contagious, the user may have to throw out the entire trapping device with the caught mouse. The mouse trapped in the cage may have to be removed via inserting their hands into the cage to catch the trapped mouse. Thus, the directly touching the mouse may not be avoidable. The trapping device can barely avoid hurting the mouse, so that the injured or killed mouse may generate a corpse like odor to arise another health issue.

Therefore, the present invention provides a mouse catcher, which comprises a container which is able to accommodate two or more mice therewithin, and a one directional tunnel communicatively connected to the directional tunnel for safely guiding a mouse entering into the container, so as to trap the mouse therewithin. Therefore, the mouse catcher is able to safely catch two or more mice into the container, and the securely keep the caught mice within the container.

### SUMMARY OF THE PRESENT INVENTION

An object of the present invention is to provide a mouse catcher, which is able to catch two or more mouse alive within the container.

Another object of the present invention is to provide a mouse catcher, which is able to safely trap the mouse without causing injury to the mouse, so as to lure another mouse entering the container by the safely caught mouse alive therewithin.

Another object of the present invention is to provide a mouse catcher, wherein the transitional container is able to guide the mouse entered thereinto from the one directional tunnel to the accommodating container, so as to securely gather the mouse within the accommodating container.

Another object of the present invention is to provide a mouse catcher, wherein the pivotal platform incorporating with the one way gate for providing the one directional mechanism is simple in structure, and no complicated electrical arrangement is involved, so as to minimize the manufacturing cost.

Another object of the present invention is to provide a mouse catcher, wherein the elevated platform and the spring board are able to effectively prevent the mouse reversely entering into the transitional housing.

Another object of the present invention is to provide a mouse catcher, wherein the sliding panel is able to remove the caught mice within the container without directly touching the mice, so as to prevent the contagious disease.

Another object of the present invention is to provide a mouse catcher, wherein mouse catcher is able reusable or disposable.

Accordingly, in order to accomplish the above objects, the present invention provides a mouse catcher, which comprises:

a container for accommodating two or more mice therewithin;

a one directional tunnel communicatively connected to the container for safely guiding one mouse at a time passing from of the tunnel to the container through a door entrance in a one way manner;

a one directional mechanism provided for allowing the mouse entering only from the one directional tunnel into the container, wherein the one directional mechanism comprises a one way gate movably coupling at the door entrance for communicatively guiding the mouse entering only from the tunnel to the container through the one way gate in the one way manner; and

a bait vessel provided within the container for luring the mouse to pass the one directional tunnel into the container through the door entrance, so that the mouse is safely caught and accommodated within the container without hurting the mouse, such that the safely caught mouse or mice are able to attract more mice entering the container through an tunnel opening of the one directional tunnel, so as to catch two or more mice.

These and other objectives, features, and advantages of the present invention will become apparent from the following detailed description, the accompanying drawings, and the appended claims.

### BRIEF DESCRIPTION OF THE DRAWINGS

FIG. 1 is a perspective 3-dimensional view of a mouse catcher according to a preferred embodiment of the present invention.

FIG. 2 is a perspective sectional view of the mouse catcher according to the above preferred embodiment of the present invention.

FIG. 3A is a partially sectional view of an one directional tunnel of the mouse catcher according to the above preferred embodiment of the present invention, illustrating an one directional arrangement of the tunnel at a first position.

FIG. 3B is a partially sectional view of an one directional tunnel of the mouse catcher according to the above preferred embodiment of the present invention, illustrating the one directional arrangement of the tunnel at a transitional position.

FIG. 3C is a partially sectional view of an one directional tunnel of the mouse catcher according to the above preferred embodiment of the present invention, illustrating the one directional arrangement of the tunnel at a second position, so as to trap the mouse within a container.

FIG. 4 is a partially sectional view of the container of the mouse catcher according to the above preferred embodiment of the present invention, illustrating the elevated platform and the spring board in the container.

### DETAILED DESCRIPTION OF THE PREFERRED EMBODIMENT

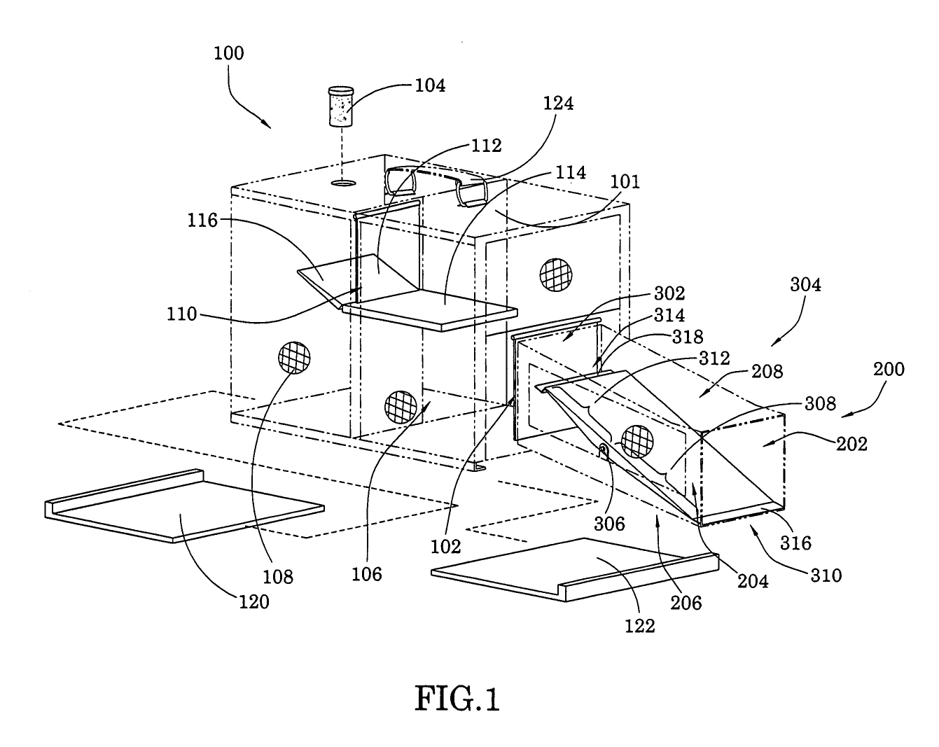

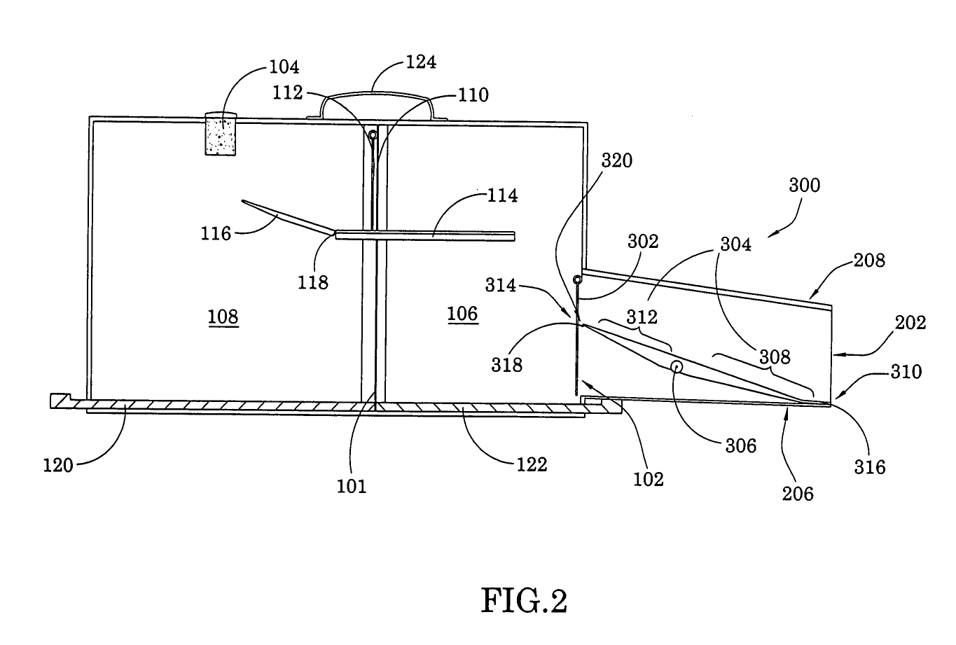

Referring to FIGS. 1 to 4 of the drawings, a mouse catcher according to a preferred embodiment of the present invention is illustrated, wherein the mouse catcher comprises a container 100 having a door entrance 102, and a one directional tunnel 200 communicatively connected to the container 100 for safely guiding one mouse at a time entering from the one directional tunnel 200 into the container 100 in a one way manner, so as to catch and gather the mice therewithin. Therefore, the mouse is unable to escape out of the container 100 through the one directional tunnel 200.

Accordingly, the one directional tunnel 200 has a size only allowing one mouse passing through at a time, wherein the one directional tunnel 200 has a trapezoidal cross section that the size of the one directional tunnel 200 is gradually enlarged from a tunnel opening 202 towards the door entrance 102.

The mouse catcher further comprises a one directional mechanism 300 for only allowing the mouse entering from the one directional tunnel 100 to the container 200 through the door entrance 102 communicatively provided therebetween in the one way manner. The one directional mechanism 300 further comprises a one way gate 302 movably coupling at the door entrance 102 for only allowing the mouse to enter from the one directional tunnel 100 into the container 200, so as to be caught and retained therewithin.

In order to lure the mouse passing the one directional tunnel 200 into the container 100, a bait vessel 104 is further provided within the container 100 at the ceiling thereof for luring the mouse entering the container 100 through the one way gate 302. The bait vessel 104 is preferably embodied as a cylindrical container for containing mouse bait or any bait therewithin for attracting rodents, wherein the bait vessel 104 is preferred to be fixedly positioned at a top wall of the container to suspendedly support within the container 100, so as to lure the mouse therewithin.

It is worth to mention that most of the mice are clustering animals, and preferred to live in a group in a hole underneath the house or the likes. The present invention provides the one way gate 302 movably coupling at the door entrance 102 between the container 100 and the one directional tunnel 200, and incorporating with the one directional mechanism 300.

Therefore, the one way gate 302 is able to safely and automatically open in the one way manner to guide the mouse entering the door entrance 102 through the one way gate 302 of the one directional mechanism 300, such that the safely caught mouse accommodated within the container 100 is able to a lure other mouse into entering the container 100. It will be readily appreciated that the mouse catcher of the present invention being able to safely catch the mouse is able to catch more than just one mouse, so that the group of mice in the house is able to be lured into the container 100 through the one directional tunnel 200 via the mouse catcher.

The one directional mechanism 300 further comprises a pivotal platform 304 pivotally coupling with a pivot axle 306 for moving between a first position and a second position. Accordingly, at the first position, the pivotal platform 304 is pivotally moved to close the door entrance 102 and to open up the tunnel opening 202 for enabling the mouse entering into the one directional tunnel 200 through the tunnel opening 202. At the second position, the pivotal platform 304 is pivotally moved to close the tunnel opening 202 and to open up the door entrance 102 for prohibiting the mouse escaping from the tunnel opening 202.

The pivot axle 306 is preferred to transversely extend through two side walls 204 of the one directional tunnel 200 between the lower portions of the side walls 204. In other words, the pivot axle 306 is pivotally coupling with two side walls 204 at a position above a bottom wall 206 with a predetermined height therefrom, so that the pivotal platform 304 is able to pivotally coupling with the pivot axle 306 for moving between the first and second positions of the pivotal platform 304 within the one directional tunnel 200 in the one way manner.

Accordingly, the pivot axle 306 is pivotally coupling with the pivotal platform 304 to define a distal end portion 308 and a proximal end portion 312. The distal end portion 308 is disposed adjacent to the tunnel opening 202 of the one directional tunnel 200 from the pivot axle 306 to a distal end 310 of the pivotal platform 304. In other words, the pivotal platform 304 pivotally moves in a seesaw manner to guide the mouse entering into the one directional tunnel 200 through the tunnel opening 202. The proximal end portion 312 is operatively engaging with the one way gate 302 via a proximal end 314 of the pivotal platform 304.

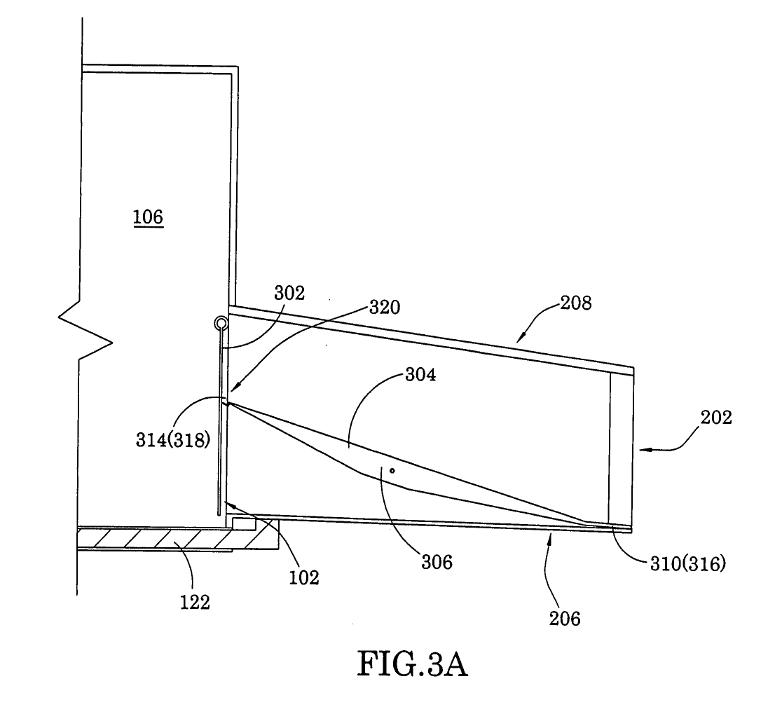

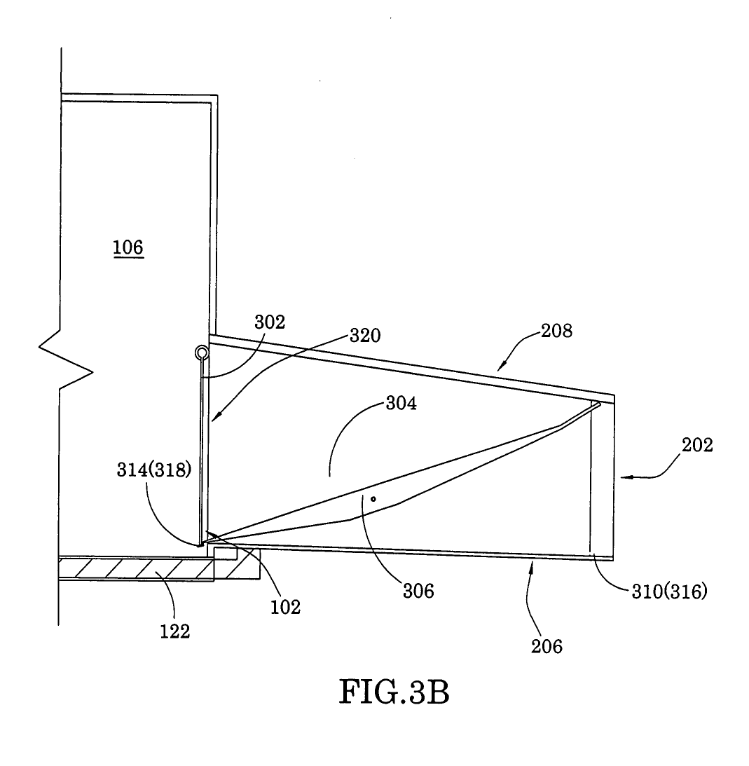

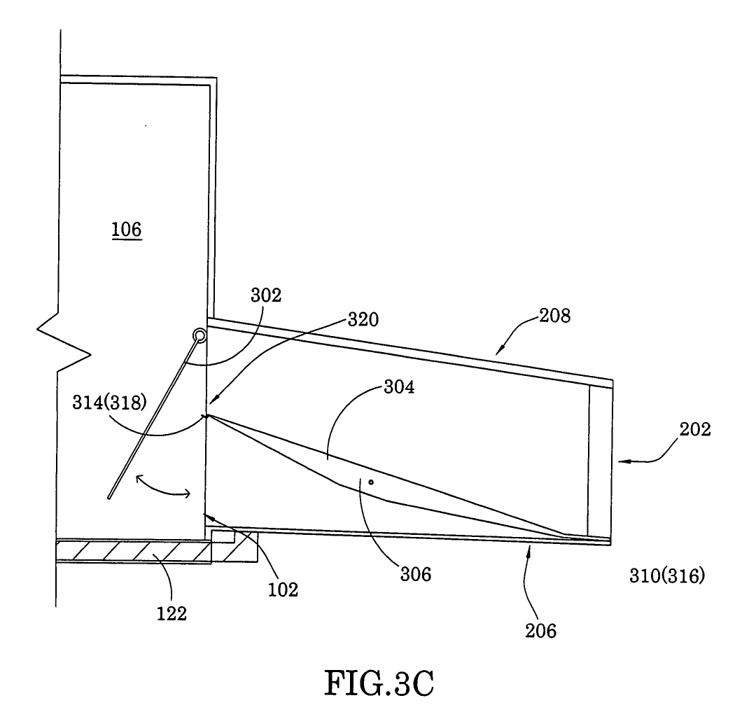

Therefore, at the first position of the pivotal platform 304 of the one directional mechanism 300, the distal end 310 of the pivotal platform 304 disposed adjacent to the tunnel opening 202 is against the bottom wall 206 of the one directional tunnel 200 at the tunnel opening 202, as shown in FIG. 3A. At the second position of the pivotal platform 304, the proximal end portion 312 is pivotally and downwardly moved to the second position. In other words, the distal end 310 is against a top wall 208 of the tunnel 200 at the tunnel opening 202, as shown in FIG. 3B. In other words, the pivotal platform 304 is pivotally moved in a seesaw manner that when the pivotal platform 304 is pivotally moved at the first position, the distal end 310 of the pivotal platform 304 biases against the bottom wall 206 of the one directional tunnel 200 to open up the tunnel opening 202 while the proximal end 314 of the pivotal platform 304 pivotally lifted up to close the door entrance 102. When the pivotal platform 304 is pivotally moved at the second position, the distal end 310 of the pivotal platform 304 biases against the top wall 208 of the one directional tunnel 200 to close the tunnel opening 202 while the proximal end 314 of the pivotal platform 304 is pivotally dropped down to open up the door entrance 102.

As mentioned above, the distal end portion 308 is preferably has a longer length from the pivot axle 306 to the distal end 310 than a length of the proximal end portion 312 from the pivot axle 306 to the proximal end 314. Thus, at the first position, the distal end portion 308 has a larger torque force than the proximal end portion 312, such that when there are no external forces, the distal end 310 automatically goes down to the first position to guide the mouse passing the one directional tunnel 200 through the pivotal platform 304. After the mouse passing from the distal end portion 308 to the proximal end portion 312, the weight of the mouse itself applies a torque force downwardly pushing the proximal end portion 312 to pivotally move to the second position, and interlock the pivotal platform 304 via being interlocked by the one way gate 302 to prohibit the mouse going to the other direction to escape.

In other words, when the pivotal platform 304 is being actuated to move to the second position by the weight of the mouse or other animals themselves, the proximal end 314 is being interlocked with a bottom side of the one way gate 302 and the distal end 310 is against the top wall 208 of the one directional tunnel 200 at the tunnel opening 202, so as to close the tunnel opening 202. Therefore, the one directional tunnel 200 is opened for the mouse entering therein when the pivotal platform 304 is pivotally moved at the first position.

The one way gate 302 is preferred to pivotally coupling at the door entrance 102 for being moved only at a direction toward the container 100, such that the one way gate 302 can only pivotally swing towards the container 100 in one direction manner. When the pivotal platform 304 is interlocked with the one way gate 302 at the second position, the mouse within the pivotal platform 304, top wall 208, two side walls 204, and the one way gate 302 is only able to move from the one directional tunnel 200 to the container 100 through the door entrance 202. As shown in FIG. 3B, the bottom edge of the one way gate 302 is engaged with the proximal end 314 of the pivotal platform 304 to retain the pivotal platform 304 at the second position. Accordingly, the pivotal platform 304 further has an engaging groove 320 longitudinally provided at the proximal end 314 of the pivotal platform 304 to engage with the bottom edge of the one way gate 302.

As shown in FIG. 3C, after the one way gate 302 is being actuated by the caught mouse to move toward the container 100 to allow the mouse entering therein in the one way manner, the interlock between the pivotal platform 304 and the one way gate 302 is released to automatically move back to the first position by the larger torque force of the distal end portion 308 while the mouse is pushing the one way gate 302 toward the container 100, so as to allow the mouse entering the container 100 for being caught and allow another mouse entering the one directional tunnel 200 via the pivotal platform 304 of the one directional mechanism 300 at the first position.

As will be readily appreciated that the one way gate 302 may be actuated by a sensor for automatically open the gate for allowing the mouse entering therefrom in the one way manner. The one way gate 302 can also be incorporated with other mechanism or electrical methods for actuating the one way gate 302 in the one way manner. It is worth to mention that the pivotal platform 304 of the one directional mechanism 300 of the present invention incorporating with the one way gate 302 of the one directional mechanism 300 is simple in structure and no complicated electrical arrangement is involved, so as to minimize the manufacturing cost. Also, there has no requirement of providing the electricity for the mouse catcher, so that the mouse catcher is convenient and easily to use.

It will be appreciated that the pivotal platform 304 incorporating with the one way gate 302 are able to safely guiding the mouse passing through the one directional tunnel 200 into the container 100, so that the safely caught mouse is able to decoy more mice entering the container 100 since the caught mouse or mice are still safely living in the container 100.

Accordingly, the pivotal platform 304 further has a first tilting portion 316 formed at the distal end 310 and a second tilting portion 318 formed at the proximal end 314, wherein the first and second tilting portions 316, 318 are formed a flat surface respectively for alternatively overlaying with a surface of the bottom wall 206 of the one directional tunnel 200. In other words, when the pivotal platform 304 is pivotally moved to the first position, the first tilting portion 316 is overlapping on the surface of the bottom wall 206 of the tunnel 200 for guiding the mouse passing the one directional tunnel 200 through the tunnel opening 202; when the pivotal platform 304 is pivotally moved to the second position, the second tilting portion 318 is overlapping with the surface of the bottom wall 206 for interlocking the second tilting portion 318 of the pivotal platform 304 underneath the bottom edge of the one way gate 302, so as to direct the mouse entering into the container 100 through the one way gate 302 in the one way manner. Accordingly, the engaging groove 320 is longitudinally indented at the second tilting portion of the pivotal platform 304.

The container 100 preferably has a transitional housing 106 communicatively connected to the one directional tunnel 200 via the door entrance 102, and an accommodating housing 108 communicatively connecting to the transitional housing 106. Accordingly, the container 100 comprises a compartment wall 101 to divide the container 100 into the transitional housing 106 and the accommodating housing 108, such that the compartment wall 101 is formed between the transitional housing 106 and the accommodating housing 108.

The bait vessel 104 is preferably provided within the accommodating housing 108 for luring the mouse entering from the transitional housing 106 into the accommodating housing 108, such that two or more mice are able to be gathered within the accommodating housing 108. It is worth to mention that the accommodating housing 108 is able to prevent the mouse staying in the transitional housing 106 to escape while another mouse is entering the container 100 via the door entrance 102.

Accordingly, a through opening 110 is formed at the compartment wall 101 between the transitional housing 106 and the accommodating housing 108 for communicating therebetween, so that the mouse is able to be lured into the accommodating housing 108 via the bait vessel 104 therewithin. Preferably, the through opening 110 is positioned at an upper portion of the compartment wall 101. A one way door 112 is further provided for movably coupling at the through opening 110 for allowing the mouse entering only in a direction from the transitional housing 106 to the accommodating housing 108. The one way door 112 is embodied as pivotally coupling at a top side of the through opening 110 and being pushed only toward the accommodating housing 108 in the one way manner.

It is appreciated that the compartment wall 101, the side walls and the top walls of the container 100 preferably have a net shaped surface, so as to be seen through inside of the container 100 and for luring other mice by the safely caught alive mouse within the container 100.

An elevated platform 114 is further provided within the container 100 at a position extended through the through opening 110 for communicating between the accommodating housing 108 and the transitional housing 106, so that the mouse or other animals are able to climb on the net shaped side walls of the container 100 to the elevated platform 114, which is extended through the through opening 110 at a bottom side thereof.

In other words, the elevated platform 114 is extended through a gap between a bottom side of the one way door 112 and the through opening 114. A portion of the elevated platform 114 is extended in the transitional housing 106 and the other portion of the elevated platform 114 is extended in the accommodating housing 108. Thus, the mouse is able to climb onto the elevated platform 114 of the portion in the transitional housing 106 to the other portion of the elevated platform 114 extended in the accommodating housing 108 through the one way door 112 in the one way manner.

It is appreciated that a climbing stair or the likes may provided within the transitional housing 106 for the mouse being able to reach the elevated platform 114, so as to enter into the accommodating housing 108 through the through opening 110.

As described above, a spring board 116 is movably extended from the elevated platform 114 within the accommodating housing 108, as shown in FIGS. 1, 2 and 4. In other words, the spring board 116 is preferably extended from one end of the elevated platform 114 to pivotally couple with the elevated platform 114 via a spring 118, such as a torsion spring, to provide a spring motion to the spring board 116. Accordingly, the spring 118 is a coil spring having one end coupling with the spring board 116 and an opposed end coupling with the elevated platform 1114 for applying an upward pushing force against the spring board 116. Preferably, the spring board 116 is inclinedly and pivotally extended from the elevated platform 114 such that the spring board 116 is upwardly and forwardly extended from the elevated platform 114 towards the bait vessel 104. Therefore, when the mouse is passing the elevated platform 114 through the one way door 112 to step on the spring board 116, the spring 118 is being elastically deformed to bend the spring board 116 by the weight of the mouse for providing a spring motion, which is able to downwardly fold the spring board 116 to ensure the mouse being fallen into the accommodating housing 108. After the mouse got off the spring board 116, a resilience force of the spring 118 is restored to push the spring board 116 returning to its original position.

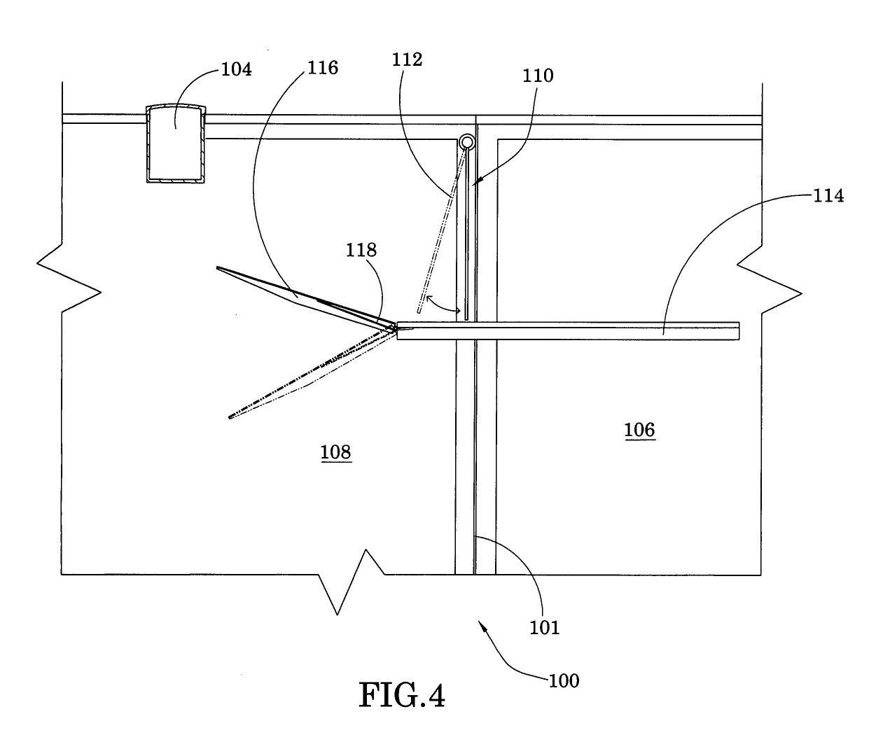

As best shown in FIG. 4, an opposed end of the spring board 116 is preferred to extend toward the bait vessel 104 for luring the mouse passing onto the spring board 116, wherein the opposed end of the spring board 116 and the bait vessel 104 have a predetermined distance therebetween, so that when the mouse is trying to reach the bait within the bait vessel 104, which is preferably provided at the top wall of the accommodating housing 108, the spring board 116 is elastically deformed to downwardly drop off the mouse. Therefore, the mouse is unable to reach the bait vessel 104 and can hardly climb to the elevated platform 114.

It will be appreciated that the portion of the elevated platform 114 in the accommodating housing 108 preferably has a smaller surface thereon than the portion of the elevated platform 114 in the transitional housing 106, so as to further prevent and minimize any possibility of the mouse reversely entering back into the transitional housing 106. Thus, the mouse can barely climb onto the spring board 116 as well as the elevated platform 114 within the accommodating housing 108, so as to prevent the mouse reversely entering into the transitional housing 106 of the container 100. In addition, the space of the accommodating housing 108 is bigger than the space of the transitional housing 106 because the transitional housing 106 is arranged for temporary housing the mouse entering from the one directional tunnel 200, while the accommodating housing 108 is big enough to house two or more mice therein at the same time.

In order to conveniently remove the caught mouse or mice within the container 100, one or more sliding panels are preferably provided at the side walls or bottom wall of the container 100. In the preferred embodiment, a first sliding panel 120 is preferably provided at a bottom portion of the accommodating housing 108 of the container 100. More specifically, the first sliding panel 120 is slidably inserted into two grooves at two peripheral edges of the bottom portion of the accommodating housing 108, so that when the first sliding panel 120 is sidewardly slid out of the grooves to disengage the sliding panel 120 with the grooves at the bottom wall of the accommodating housing 108, the collected mouse or mice therewithin are able to be removed without touching the mouse, so as to reduce infection possibility from the mouse.

A second sliding panel 122 may be further provided at a bottom portion of the transitional housing 106 for slidably engaging with two grooves at two peripheral edges of the bottom portion of the transitional housing 106, such that when the mouse doesn't enter into the accommodating housing 108, the second sliding panel 122 is able to slidably disengaging with the grooves for removing the mouse within the transitional housing 106. Accordingly, the first and second sliding panels 120, 122 form as a floor of the accommodating housing 108 and the transitional housing 106 respectively.

A handle bar 124 is preferably provided at an outer surface of the top wall of the container 100 for portably carrying the mouse catcher to a desired location. In addition, the handle bar 124 is able to be held for lifting the container 100 while sliding out the first or second sliding panels 120, 122 for removing the mouse therewithin.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A mouse catcher, comprising:
a container for accommodating two or more mice therewithin, wherein said container has a door entrance;
a one directional tunnel having a tunnel opening communicating with said container for safely guiding one mouse at a time passing from said one directional tunnel to said container through said door entrance;
a bait vessel provided within said container for luring said mouse to pass said one directional tunnel into said container through said door entrance, so that said mouse is safely caught and accommodated within said container without hurting said mouse; and
a one directional mechanism provided in said one directional tunnel for allowing said mouse entering from said one directional tunnel into said container in one direction manner, such that said safely caught mouse or mice are able to attract more mice entering said container through said one directional tunnel, so as to catch two or more mice.

2. The mouse catcher, as recited in claim 1, wherein said one directional mechanism comprises a one way gate pivotally coupling at said door entrance in one direction towards said container for prohibiting said mouse escaping back to said one directional tunnel once said mouse enters into said container.

3. The mouse catcher, as recited in claim 1, wherein said one directional mechanism comprises a pivotal platform pivotally supported within said one directional tunnel to pivotally move between a first position and a second position, wherein at said first position, said pivotal platform is pivotally moved to close said door entrance and to open up said tunnel opening for enabling said mouse entering into said one directional tunnel through said tunnel opening, and wherein at said second position, said pivotal platform is pivotally moved to close said tunnel opening and to open up said door entrance for prohibiting said mouse escaping from said tunnel opening.

4. The mouse catcher, as recited in claim 2, wherein said one directional mechanism comprises a pivotal platform pivotally supported within said one directional tunnel to pivotally move between a first position and a second position, wherein at said first position, said pivotal platform is pivotally moved to close said door entrance and to open up said tunnel opening for enabling said mouse entering into said one directional tunnel through said tunnel opening, and wherein at said second position, said pivotal platform is pivotally moved to close said tunnel opening and to open up said door entrance for prohibiting said mouse escaping from said tunnel opening.

5. The mouse catcher, as recited in claim 3, wherein said pivotal platform is pivotally moved in a seesaw manner that when said pivotal platform is pivotally moved at said first position, a distal end of said pivotal platform biases against a bottom wall of said one directional tunnel to open up said tunnel opening while a proximal end of said pivotal platform pivotally lifted up to close said door entrance, and when said pivotal platform is pivotally moved at said second position, said distal end of said pivotal platform biases against a top wall of said one directional tunnel to close said tunnel opening while said proximal end of said pivotal platform is pivotally dropped down to open up said door entrance.

6. The mouse catcher, as recited in claim 4, wherein said pivotal platform is pivotally moved in a seesaw manner that when said pivotal platform is pivotally moved at said first position, a distal end of said pivotal platform biases against a bottom wall of said one directional tunnel to open up said tunnel opening while a proximal end of said pivotal platform pivotally lifted up to close said door entrance, and when said pivotal platform is pivotally moved at said second position, said distal end of said pivotal platform biases against a top wall of said one directional tunnel to close said tunnel opening while said proximal end of said pivotal platform is pivotally dropped down to open up said door entrance.

7. The mouse catcher, as recited in claim 4, wherein said pivotal platform is pivotally supported by a pivot axle to define a distal end portion between said pivot axle and said distal end and a proximal end portion between said pivot axle and said proximal end, wherein a length of said distal end portion is longer than a length of said proximal end portion.

8. The mouse catcher, as recited in claim 6, wherein said pivotal platform is pivotally supported by a pivot axle to define a distal end portion between said pivot axle and said distal end and a proximal end portion between said pivot axle and said proximal end, wherein a length of said distal end portion is longer than a length of said proximal end portion.

9. The mouse catcher, as recited in claim 4, wherein a bottom edge of said one way gate is releasably engaged with said pivotal platform to retain said pivotal platform at said second position, wherein when said one way gate is pivotally swung towards said container, said pivotal platform is released from said one way gate to to pivotally move back to said first position from said second position.

10. The mouse catcher, as recited in claim 6, wherein a bottom edge of said one way gate is releasably engaged with said pivotal platform to retain said pivotal platform at said second position, wherein when said one way gate is pivotally swung towards said container, said pivotal platform is released from said one way gate to pivotally move back to said first position from said second position.

11. The mouse catcher, as recited in claim 8, wherein a bottom edge of said one way gate is releasably engaged with said pivotal platform to retain said pivotal platform at said second position, wherein when said one way gate is pivotally swung towards said container, said pivotal platform is released from said one way gate to pivotally move back to said first position from said second position.

12. The mouse catcher, as recited in claim 10, wherein said pivotal platform further has an engaging groove longitudinally provided at said proximal end of said pivotal platform to engage with said bottom edge of said one way gate when said pivotal platform is pivotally moved to said second position.

13. The mouse catcher, as recited in claim 11, wherein said pivotal platform further has an engaging groove longitudinally provided at said proximal end of said pivotal platform to engage with said bottom edge of said one way gate when said pivotal platform is pivotally moved to said second position.

14. The mouse catcher, as recited in claim 1, wherein said container comprises a compartment wall to divide said container into a transitional housing for temporary housing said mouse entering from said one directional tunnel, and an accommodating housing for housing two or more mice therein at the same time, and a one way door provided at said compartment wall to communicate said transitional housing with said accommodating housing in one direction manner for preventing said mouse in said accommodating housing returning back to said transitional housing.

15. The mouse catcher, as recited in claim 13, wherein said container comprises a compartment wall to divide said container into a transitional housing for temporary housing said mouse entering from said one directional tunnel, and an accommodating housing for housing two or more mice therein at the same time, and a one way door provided at said compartment wall to communicate said transitional housing with said accommodating housing in one direction manner for preventing said mouse in said accommodating housing returning back to said transitional housing.

16. The mouse catcher, as recited in claim 14, wherein said container further comprises an elevated platform having a portion extended in said transitional housing and another portion extended in said accommodating housing for guiding said mouse entering from said transitional housing to said accommodating housing through said one way door.

17. The mouse catcher, as recited in claim 15, wherein said container further comprises an elevated platform having a portion extended in said transitional housing and another portion extended in said accommodating housing for guiding said mouse entering from said transitional housing to said accommodating housing through said one way door.

18. The mouse catcher, as recited in claim 16, wherein said container further comprises a spring board pivotally extended from said elevated platform within said accommodating housing and arranged to pivotally and downwardly fold when said mouse steps on said spring board for ensuring said mouse being fallen within said accommodating housing.

19. The mouse catcher, as recited in claim 17, wherein said container further comprises a spring board pivotally extended from said elevated platform within said accommodating housing and arranged to pivotally and downwardly fold when said mouse steps on said spring board for ensuring said mouse being fallen within said accommodating housing.

20. The mouse catcher, as recited in claim 14, wherein said container further comprises a first sliding panel detachably coupling at a bottom portion of said accommodating housing and a second sliding panel detachably coupling at a bottom portion of said transitional housing.

21. The mouse catcher, as recited in claim 19, wherein said container further comprises a first sliding panel detachably coupling at a bottom portion of said accommodating housing and a second sliding panel detachably coupling at a bottom portion of said transitional housing.
